(19) United States
(12) Patent Application Publication
(10) Pub. No.: US 2011/0078731 A1
(43) Pub. Date: Mar. 31, 2011

(54) SYSTEMS AND METHODS FOR MULTIPLE MEDIA GUIDANCE APPLICATION NAVIGATION

(75) Inventor: Akitaka Nishimura, Tokyo (JP)

(73) Assignee: Rovi Technologies Corporation, Santa Clara, CA (US)

(21) Appl. No.: 12/567,009

(22) Filed: Sep. 25, 2009

(51) Int. Cl. H04N 5/445; G09G 5/00; G06F 3/048

(52) U.S. Cl. 725/39; 345/156; 715/781

(57) ABSTRACT

Systems and methods for allowing a user to access media guidance application settings from any given mobile device and centralize the settings using a media equipment device are provided. One or more mobile devices may be detected with a media equipment device. The media equipment device may receive mobile media guidance application settings from the detected mobile devices. The media equipment device may replicate a mobile media guidance application for each of the detected mobile devices based on the received settings. Access to the replicated mobile media guidance applications associated with the detected mobile devices may be provided on the media equipment device. Changes to the settings of the replicated mobile media guidance applications associated with the detected mobile devices may be tracked and transmitted to the corresponding mobile device. The mobile device may modify a mobile media guidance application based on the changes received from the media equipment device.

### BACKGROUND OF THE INVENTION

This application relates to interactive media guidance applications and more particularly to multiple media guidance application navigation.

Traditional systems allow a user to navigate an interactive program guide (IPG) using various devices such as mobile devices, computers and other media equipment devices. When navigating an IPG on a mobile device, the user is limited to the navigational equipment (e.g., screen and keypads) of the mobile device which are not optimal for performing various operations (e.g., searching for programs and scheduling recordings). Additionally, because each mobile device provides a user interface for the IPG that is specific to the mobile device, the user must learn different navigation techniques to use depending on which mobile device the user is accessing.

### SUMMARY OF THE INVENTION

In view of the foregoing, it would be desirable to provide systems and methods for multiple media guidance application navigation. In particular, it would be desirable to provide a system that allows a user to view and access media guidance application settings from any given mobile device (e.g., cell phone or portable gaming machine) and centralize those settings using a media equipment device (e.g., set top box).

In some embodiments, a first mobile device may be detected with a media equipment device. The media equipment device may receive a mobile media guidance application data structure from the first mobile device. The media equipment device may replicate the mobile media guidance application (or generate a media guidance application) associated with the first mobile device based on settings stored in the received data structure. Access to the replicated media guidance application associated with the first mobile device may be provided on the media equipment device.

The media equipment device may store or track changes to the settings made to the replicated media guidance application on the media equipment device and transmit a data structure with the changes to the settings to the first mobile device. In some embodiments, the user may modify display characteristics (e.g., the appearance of menu options and items in the mobile media guidance application and which menu options are provided) of the replicated media guidance application as the changed settings. In some implementations, changes to the display characteristics may be made through a guide customization screen on the media equipment device. The first mobile device may modify the mobile media guidance application implemented on the first mobile device using information in the data structure received from the media equipment device.

In some embodiments, a second mobile device may be detected with the media equipment device. The media equipment device may receive a mobile media guidance application data structure from the second mobile device. The media equipment device may replicate the mobile media guidance application (or generate a media guidance application) associated with the second mobile device based on settings stored in the received data structure. The media equipment device may provide a display that includes multiple media guidance applications in windows to provide access to each of the replicated or generated mobile media guidance applications associated with the first and second mobile devices.

In some embodiments, access to each of the replicated mobile media guidance applications associated with the first and second mobile devices may be provided in one window using a tabbed guide approach. In particular, each replicated mobile media guidance application that is associated with a different mobile device may be indicated with a different tab of the tab display. Selection of one of the tabs in the tab display, may cause the replicated mobile media guidance application associated with the mobile device corresponding to the selected tab to be retrieved and displayed in a region adjacent to the tab display.

In some embodiments, settings from a replicated mobile media guidance application associated with a first mobile device may be modified using the media equipment device and transmitted in the form of a data structure to a second mobile device. In particular, settings of mobile media guidance applications implemented on various mobile devices may be synchronized such that all the settings associated with the different devices are the same and consistent among the devices.

In some embodiments, a replicated mobile media guidance application on the media equipment device may provide access to functionality unique to the mobile device with which the replicated mobile media guidance application is associated. In particular, the replicated mobile media guidance application on the media equipment device may be associated with a mobile phone and accordingly may provide access to telephony and SMS functionalities of the mobile phone. More specifically, the user may select an option to call a particular contact from a contacts list displayed in the replicated mobile media guidance application on the media equipment device. Resources from the media equipment device and the mobile device with which the replicated mobile media guidance application is associated may be consumed by the media equipment device to place the call to the contact.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 shows an illustrative display screen of multiple replicated mobile media guidance applications simultaneously displayed in accordance with an embodiment of the invention;

FIGS. 6 and 7 show illustrative display screens of a mobile media guidance application displayed on a mobile device in accordance with an embodiment of the invention;

FIG. 8 shows an illustrative display screen of multiple replicated mobile media guidance applications simultaneously displayed in accordance with an embodiment of the invention;

FIGS. 9 and 10 show illustrative display screens of multiple replicated mobile media guidance applications navigation in accordance with an embodiment of the invention;

FIG. 11 shows an illustrative display screen of mobile media guidance application customization in accordance with an embodiment of the invention;

FIG. 12 shows an illustrative display screen of an alert for a mobile media guidance application displayed on a mobile device in accordance with an embodiment of the invention;

FIGS. 13 and 14 show illustrative mobile media guidance application data structures in accordance with an embodiment of the invention; and

FIGS. 15 and 16 are illustrative flow diagrams for multiple replicated mobile media guidance applications navigation in accordance with embodiments of the present invention.

### DETAILED DESCRIPTION OF EMBODIMENTS

This invention generally relates to systems and methods for multiple media guidance application navigation. In particular, access to replicated mobile media guidance application settings associated with various mobile media guidance applications may be provided using a media equipment device. The settings of a given replicated mobile media guidance application may be modified using the media equipment device and transmitted back to the mobile device associated with the given media guidance application.

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

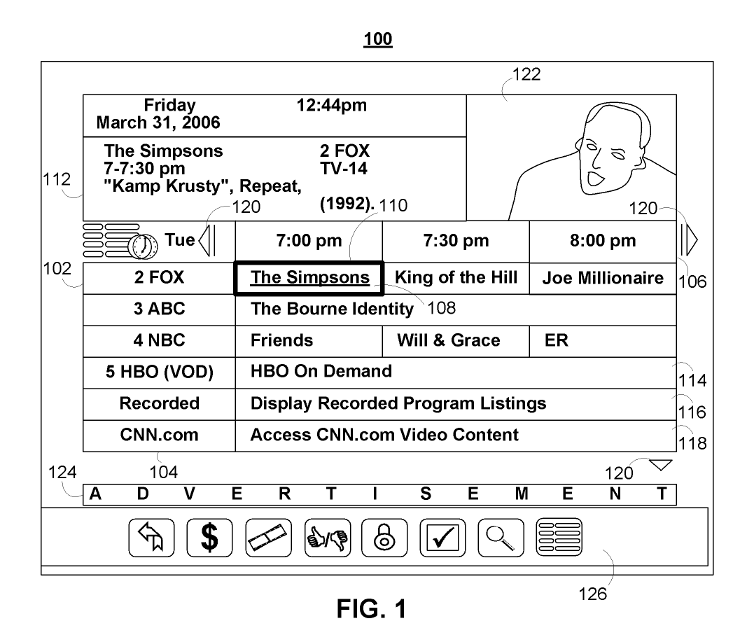

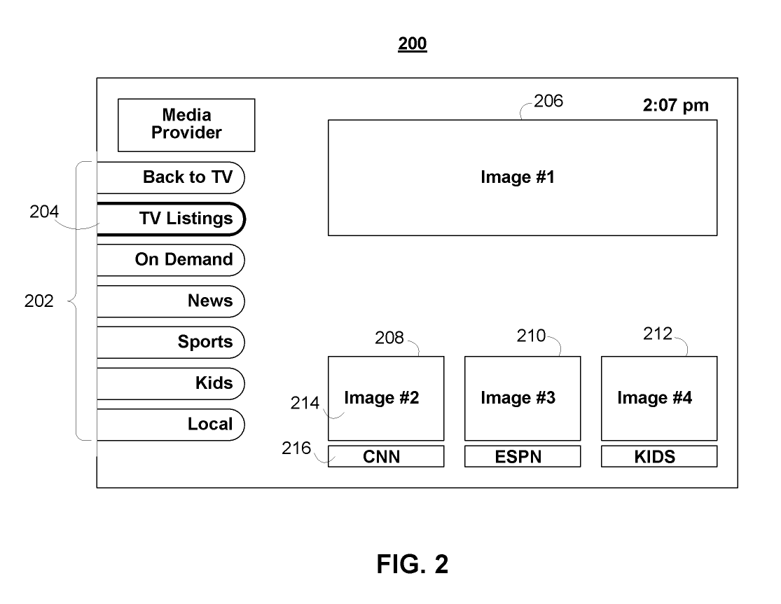

One of the functions of the media guidance application is to provide media listings and media information to users. FIGS. 1-2 show illustrative display screens that may be used to provide media guidance, and in particular media listings. The display screens shown in FIGS. 1-2 and 5-12 may be implemented on any suitable device or platform. While the displays of FIGS. 1-2 and 5-12 are illustrated as full screen displays (for the given platform), they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site (e.g., HULU or YOUTUBE) or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to (i.e., be related to) or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, scheduling a reminder for a program, ordering a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. Pat. No. 7,165,098, issued Jan. 16, 2007, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, still frames of a video associated with the listing, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

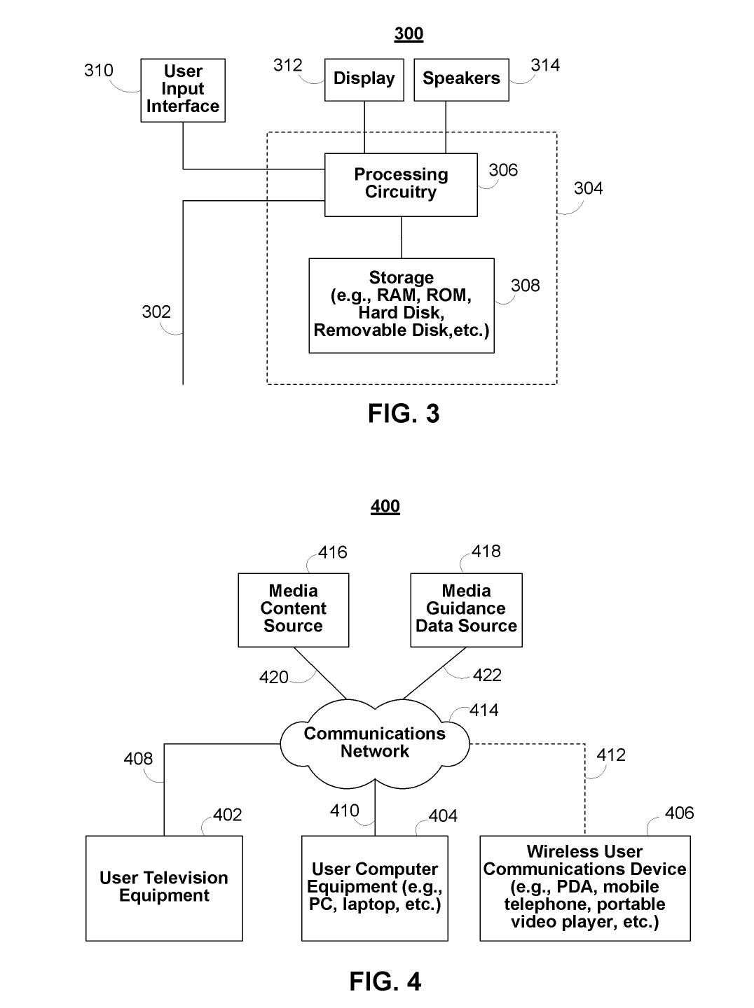

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, an Fiber To The Home (FTTH) (optical fiber) service, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), High-Density Multichip Interconnect (HDMI), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content or scheduled media asset events (e.g., reminders for media assets). For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, program orders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. User television equipment 404 may be referred to below as media equipment device. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, playlists, etc.

In some embodiments, processing circuitry 306 on a media equipment device may receive a user selection to access media guidance application settings of one or more mobile devices. Processing circuitry 306 may detect the presence of any mobile devices within a particular range of the media equipment devices. Systems and methods for detecting the presence of mobile devices are discussed in greater detail in U.S. patent application Ser. No. ______, filed ______, (Attorney Docket No. UV-495) and U.S. patent application Ser. No. 12/504,191, filed Jul. 16, 2009, each of which is incorporated by reference herein in its entirety.

Processing circuitry 306 may establish a short-range communications link (or in some implementations long-range communications link) with the detected mobile devices and receive settings associated with their respective mobile media guidance applications. Processing circuitry 306 may generate a different media guidance application for each of the detected devices that each includes the settings received from the respective mobile devices to replicate the mobile media guidance applications of the respective mobile devices. The user may access the generated media guidance applications on the media equipment device to modify attributes/settings and execute functions associated with the generated media guidance applications. By navigating the media guidance application with the settings of the mobile device using the media equipment device instead of the mobile device, the user is able to modify attributes/settings, make selections and execute functions that may otherwise be more difficult to achieve with the navigation techniques and limitations of the particular mobile device or that may otherwise exceed the processing power of the given mobile device.

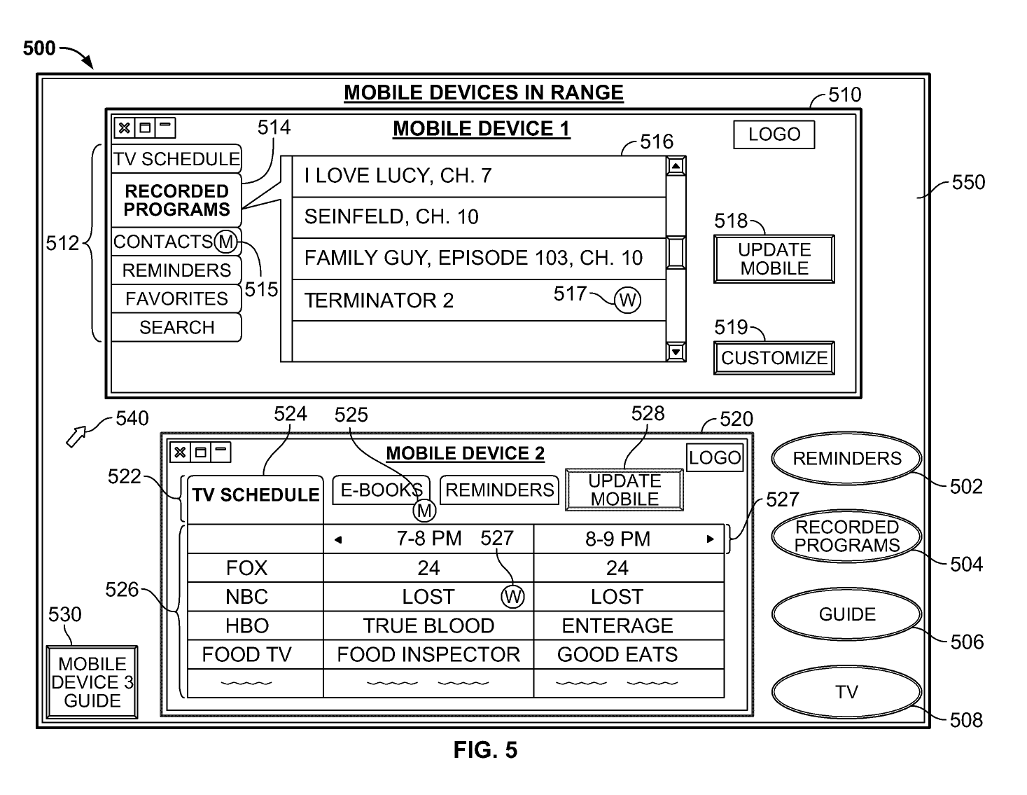

As a result of receiving the user selection to navigate the media guidance applications of mobile devices using the media equipment device, processing circuitry 306 may navigate the user to a screen that includes each of the media guidance applications generated based on the settings received from a corresponding mobile device. FIG. 5 shows an illustrative display screen 500 of multiple replicated mobile media guidance applications simultaneously displayed in accordance with an embodiment of the invention. Screen 500 may include a first window with a first media guidance application 510, a second window with a second media guidance application 520, a mobile device guide link 530, and various media guidance application options 502, 504, 506 and 508.

Screen 500 may be a navigation screen of the media guidance application running locally on the media equipment device. For example, screen 500 may be one of the various navigation screens of the media guidance application that runs on a set top box and the windows with screen 500 that include the first and second media guidance applications may be generated by the software of the media guidance application that is running on the set top box. The media guidance application that is running on the media equipment device (e.g., set top box) can therefore be thought of as the operating system of the media equipment device and as such to simplify the discussion may be referred to below as the operating system of the media equipment device. More specifically, various options 502, 504, 506 and 508 may be the options provided by the operating system of the media equipment device. Additionally, the option selected by the user to navigate to screen 500 may be provided by the operating system of the media equipment device.

Each window that includes the media guidance application 510 and 520 associated with a particular mobile device may be generated by a separate application that is executed by the operating system of the media equipment device. For example, upon establishing a link with a particular mobile device, the operating system of the media equipment device may launch a new application in a window that is programmed to perform the functions of generating the media guidance application for the mobile device. Alternatively, each window that includes the media guidance application associated with a particular mobile device may be generated by the operating system of the media equipment device as a module of the local operating system of the media equipment device.

First and second windows that include first and second media guidance applications 510 and 520 may be overlaid on top of background 550. Background 550 may be a currently tuned television channel, a video, an application, website, desktop, an operating system navigation screen, an image or any combination of the same. First and second windows that include first and second media guidance applications 510 and 520 may be partially transparent to allow the user to see the items of first and second windows that include first and second media guidance applications 510 and 520 while at the same time seeing background 550.

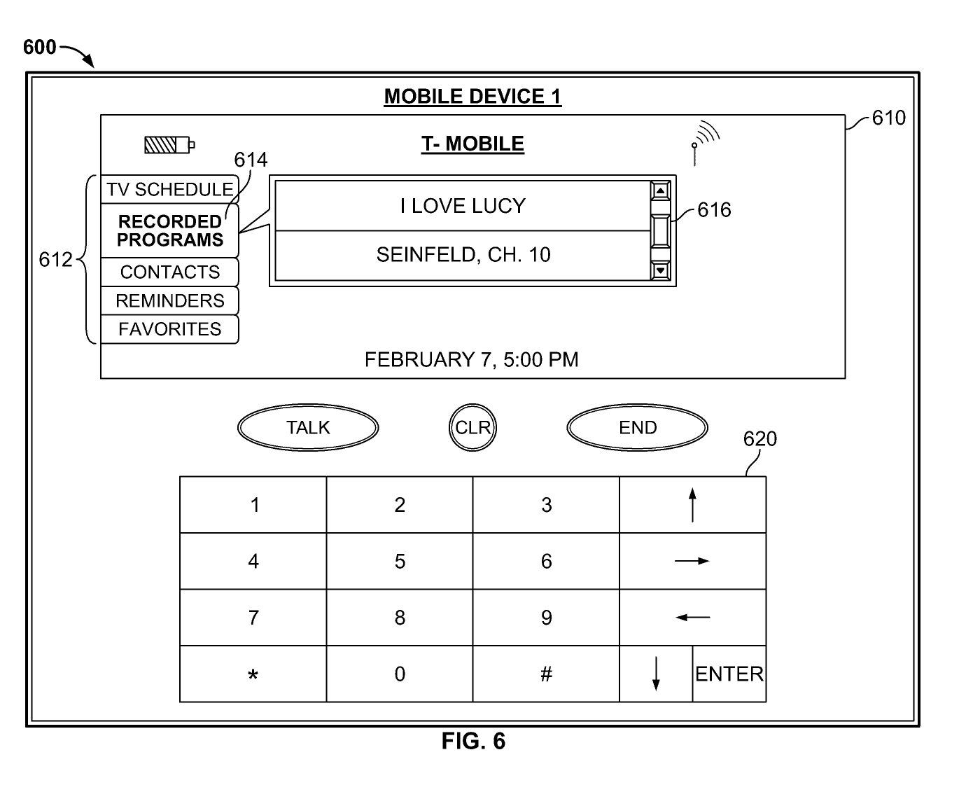

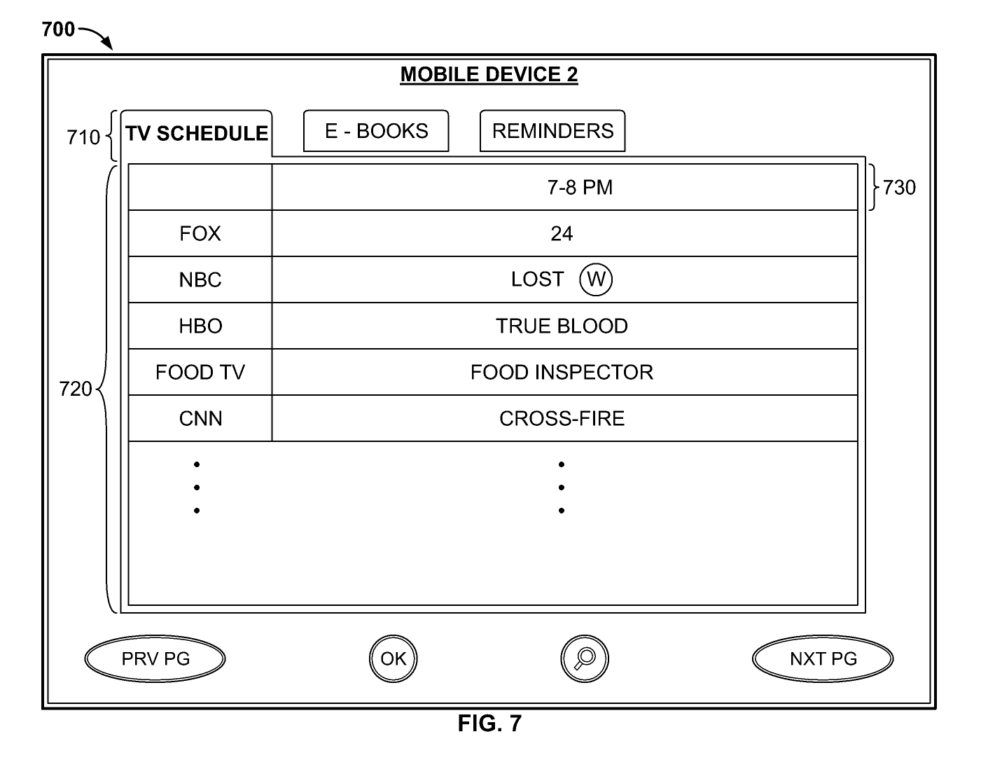

Each mobile device may display a mobile media guidance application suitable for navigation using the navigation techniques of the mobile device. FIG. 6 shows an illustrative display screen of a mobile media guidance application 610 displayed on a first mobile device 600 in accordance with an embodiment of the invention. FIG. 7 shows an illustrative display screen of a mobile media guidance application displayed on a second mobile device 700 in accordance with an embodiment of the invention. First mobile device 600 may be a mobile phone device such as a cellular telephone with a keypad navigation technique and second mobile device 700 may be an eBook mobile device with a touch screen type navigation technique for reading books on a large screen.

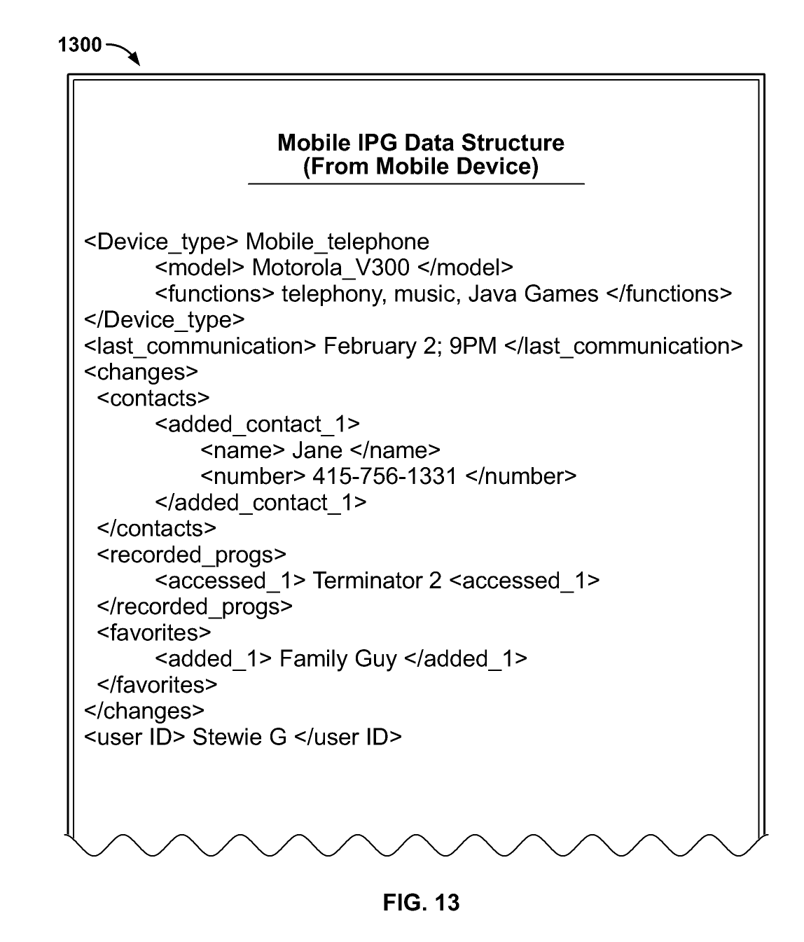

Each media guidance application 510 and 520 may be generated based on a mobile media guidance application data structure 1300 received from a corresponding mobile device to replicate the mobile media guidance application of the corresponding mobile device. For example, first media guidance application 510 may be generated based on a mobile media guidance application data structure 1300 (FIG. 13) received from first mobile device 600 (FIG. 6) and second media guidance application 520 may be generated based on a different mobile media guidance application data structure 1300 received from second mobile device 700 (FIG. 7). In particular, processing circuitry 306 may parse through various fields of mobile media guidance application data structure 1300 received from first mobile device 600 to determine whether settings have changed on first mobile device 600 since the last time a link was established between first mobile device 600 and the media equipment device.

In some embodiments, media guidance application data may only be available on or through the media equipment device and first mobile device 600 may only provide storage for personal data associated with a particular user and not any other media guidance application data. For example, the operating system of the media equipment device may allow the user to view program scheduling information provided by a remote source while first mobile device 600 may only allow the user to store personal data such as display preferences of a media guidance application viewed on the media equipment device (discussed below), favorite media asset listings, reminders, contacts information, and various other media guidance application configuration information. When a link is established between the media equipment device and first mobile device 600, the media equipment device may update the operating system parameters of the local media guidance application with personal data received from first mobile device 600 via a mobile media guidance application data structure 1300 (FIG. 13). When the user browses the media guidance application of the media equipment device (e.g., the operating system) and selects an option to view reminders or favorite media asset listings, the media equipment device may navigate the user to a display screen of the operating system that includes the reminders or favorite media asset listings the user has previously selected or set using the media equipment device as well as the reminders or favorite media asset listings that were stored on first mobile device 600.

When a link is established for the first time with first mobile device 600, processing circuitry 306 may request all the settings associated with the mobile media guidance application of first mobile device 600 to be provided (e.g., by way of additional transmission of data structures). Processing circuitry 306 may generate first media guidance application 510 based on the received settings to replicate the mobile interactive program guide of first mobile device 600 to allow the user to navigate mobile media guidance application 610 of first mobile device 600 using the media equipment device. Second media guidance application 520 may similarly be generated by processing circuitry 306 to replicate the mobile media guidance application of second mobile device 700.

For example, first media guidance application 510 may include a recorded programs option 514 in options menu 512. Processing circuitry 306 may retrieve from a recorded programs field of data structure 1300 (FIG. 13), a list of items indicating which programs that have been recorded have been accessed or deleted. In particular, processing circuitry 306 may display items 516 indicating all the programs that have been recorded and may include an indicator 517 identifying that a particular program in items 516 has been watched on the mobile device. Similarly, if the user has recorded a particular program using the mobile device and as a result a program listing associated with the recorded program has been added on the mobile media guidance application of the mobile device, processing circuitry 306 may retrieve that information from data structure 1300 and include a program listing of the recorded program in items 516.

In some embodiments, recorded programs option 514 of first media guidance application 510 may identify programs that are available for access on first mobile device 600 (e.g., have been stored to a memory of first mobile device 600) and may not identify programs that are recorded on the media equipment device. In particular, the settings included in first media guidance application 510 may relate solely to first mobile device 600 to which guide 510 corresponds. For example, when processing circuitry 306 receives a user selection of recorded programs option 504, a list of programs available for access or that have been recorded on a memory of the media equipment device may be provided. The list provided as a result of receiving a selection of recorded programs option 504 may be different from the items 516 identifying recorded programs of first media guidance application 510.

In some embodiments, recorded programs option 514 identifies programs that are available for access using a home equipment device such as the media equipment device. In such circumstances, items 516 identifying recorded programs that are available using the media equipment device may include the same program listings as the list provided when recorded programs option 504 is selected. Similarly, selection of reminders option in first media guidance application 510 may provide a list of items 516 that identifies reminders that have been scheduled with any device associated with the user or that have been scheduled using the corresponding mobile device. Preferably, the list provided when reminders option is selected using any device (e.g., mobile device or media equipment device) is the same to ensure the user gets the information associated with the reminder. In particular, if the user has added a reminder on a given mobile device, when the mobile device is linked to the media equipment device, processing circuitry 306 may include the added reminder (1) in items 516 generated with first media guidance application 510 and (2) in a list of reminders provided when the user selects reminders option 502.

Second media guidance application 520 may include a television schedule option 524 in options menu 522. Processing circuitry 306 may retrieve from a television schedule field of data structure 1300 (FIG. 13), a list of items indicating which programs have been accessed on second mobile device 700. In particular, processing circuitry 306 may display a television schedule 526 based on the received data structure and may include an indicator 527 identifying that a particular program has been watched on second mobile device 700.

In some embodiments, television schedule option 524 of second media guidance application 520 provides a television schedule of programs that is tailored to second mobile device 700 (e.g., a schedule that has been stored to a memory of second mobile device 700) and may not be the same as the television schedule provided on the media equipment device. In particular, the settings included in second media guidance application 520 may relate solely to second mobile device 700 to which guide 520 corresponds. For example, when processing circuitry 306 receives a user selection of television schedule guide option 506, a television schedule guide that is stored in a memory of the media equipment device and that relates to the media equipment device may be provided. The television schedule guide provided as a result of receiving a selection of television schedule guide option 506 may be different from television schedule 526 of second media guidance application 520.

In some implementations, the television schedule corresponding to the media equipment device that is provided as a result of a user selection of guide option 506 may be different from television schedule 526 associated with second mobile device 700 because television schedule 526 may be generated based on the television schedule data that is stored on second mobile device 700. For example, the television schedule stored on second mobile device 700 may be less up-to-date than the television schedule stored on the media equipment device and thus different from the television schedule stored on the media equipment device. This may be because updates to the mobile device may be performed once per day whereas updates to the media equipment device may be performed multiple times per day.

In some implementations, portions of the media guidance application data may only become available to the media equipment device through first mobile device 600. For example, the media equipment device may not have IPTV capabilities to receive media guidance application data (e.g., media asset information such as scheduling or access information) and first mobile device 600 may have such IPTV capabilities. In such circumstances, first mobile device 600 may provide through mobile media guidance application data structure 1300 personal data associated with a particular user (e.g., a user's favorite media asset listings, reminders, recordings, display characteristics) and media guidance application data that first mobile device 600 may have received with the IPTV capabilities of first mobile device 600. Accordingly, the media equipment device may include in the local media guidance application or in one of the windows that includes a replicated media guidance application of first mobile device 600, portions of the media guidance application data pertaining to or that were received with IPTV capabilities. In some implementations, the IPTV capabilities may be a function unique to first mobile device 600. Accordingly, the media equipment device may provide access to the functionality that is unique to first mobile device 600 (as discussed above and below).

For example, the media equipment device may provide as a result of receiving a user selection of guide option 506, a listing of programs provided over a broadcast cable or satellite source and a listing of programs provided over the Internet (e.g., on-demand programs). The media equipment device may also allow the user to select one of the listings corresponding to the programs provided over the Internet (e.g., the listings that were received from first mobile device 600 that pertain to the IPTV capabilities of first mobile device 600) and may provide access to or display the program corresponding to the selected listing using the IPTV capabilities of first mobile device 600. More specifically, the media equipment device may establish a short range communications link with first mobile device 600 and may transmit a request to first mobile device 600 instructing first mobile device 600 to retrieve or provide access to the program corresponding to the selected program listing. First mobile device 600 may consume the IPTV capabilities of first mobile device 600 to retrieve or provide access to the selected program over the Internet and may transmit the content of the selected program back to the media equipment device to allow the user to access the selected program using the media equipment device. In some implementations, this process may be fully automated such that the user need only select the program listing and the connections between the device and between the first mobile device and the Internet are seamlessly established.

In some implementations, second mobile device 700 may provide a television schedule that is tailored to the user's location (e.g., by using GPS coordinates or triangulating the user's current location). More specifically, second mobile device 700 may provide a television schedule of the city, state or country the user is or was in, while the media equipment device may always provide the same television schedule. Additionally, even though second mobile device 700 may be in the same city, state, country or location as the media equipment device, second mobile device 700 may be configured to always provide a television schedule of some different location. Accordingly, television schedule 526 generated based on the information from second mobile device 700 may be different from the television schedule of the media equipment device. Such a feature allows the user to view multiple television schedules (in some implementations simultaneously) of different locations using the media equipment device.

In some implementations, the replicated mobile media guidance application displayed on the media equipment device may be visually similar to (e.g., mirror) the mobile media guidance application displayed on the mobile device. For example, first media guidance application 510 may mirror mobile media guidance application 610 that is displayed on first mobile device 600 (FIG. 6) and second media guidance application 520 may mirror the mobile media guidance application that is displayed on second mobile device 700 (FIG. 7). For example, first media guidance application 510 may have menu options and various other items displayed in substantially the same location and in substantially the same way as they appear when displayed on the mobile device. In such circumstances, even though more space may be available on the media equipment device display, in order to avoid confusing the user, media equipment device may nevertheless limit the items provided in first media guidance application 510 to only those items that are displayed on the mobile device. In some implementations, one of the media guidance applications displayed on the media equipment device may be configured to mirror the mobile media guidance application while a second one of the media guidance applications displayed on the media equipment device may be configured to appear differently (include more/less menu options or items) than the mobile media guidance application.

In some implementations, the replicated mobile media guidance application displayed on the media equipment device may look different (have a different look and feel) than the mobile media guidance application displayed on the mobile device. For example, first media guidance application 510 may look different (have a different look and feel) than mobile media guidance application 610 that is displayed on first mobile device 600. In particular, first media guidance application 510 may have options and various other items displayed in the same manner (position and style) as they are displayed on the mobile device but more options and items may be included in the display than when displayed on the mobile device. More specifically, first media guidance application 510 may include a first menu 512 that includes all the options as the menu when displayed on the mobile device and additionally some options that are not included when displayed on the mobile device (e.g., because of the display screen size limitation of the mobile device).

For example, first media guidance application 510 looks similar to mobile media guidance application 610 and second media guidance application 520 looks similar to the mobile media guidance application displayed on second mobile device 700. Although first media guidance application 510 looks similar to mobile media guidance application 610, first media guidance application 510 is shown to include menu options that do not appear in the display of mobile media guidance application 610. In particular, first media guidance application 510 may include a search option which is not included in the display of mobile media guidance application 610 (e.g., because the screen of mobile device 600 may not be large enough to accommodate the display of six menu options).

Similarly, although second media guidance application 520 looks similar to the mobile media guidance application displayed on second mobile device 700, second media guidance application 520 is shown to include a television schedule for more time intervals than the media guidance application displayed on second mobile device 700. In particular, second media guidance application 520 may include program listings for programs broadcast during a 7-8 PM time interval and 8-9 PM time interval while the mobile media guidance application displayed on second mobile device 700 only includes program listings for programs broadcast during the 7-8 PM time interval (e.g., because the screen of mobile device 700 may not be wide enough to accommodate the display of more than one time interval).

Similarly, recorded programs menu option 514 and items 516 is shown to be selected in both guides 510 and 610, respectively. However, while first media guidance application 510 includes four items 516 corresponding to that menu option selection, mobile media guidance application 610 may only include two items 616 in the display at any given time. In order to view the items corresponding to the menu selection that are not included in the display on the mobile device, the user may scroll the display up/down. For example, scrolling items 616 down may bring into view the next item after Seinfeld in items 616 (e.g., Family Guy) which is shown in the larger version of the same display of items 516 after Seinfeld. Thus, this is one way (e.g., because of screen size) that a user is able to more efficiently and conveniently view and navigate about mobile media guidance application 610 using the media equipment device (e.g., the user may not have to scroll multiple times to view different items 616).

Another way that simplifies navigation of the mobile media guidance application by providing access to the mobile guide on the media equipment device relates to the limitation of navigation techniques available on a given mobile device. For example, the user may navigate through first media guidance application 510 and make selections and/or modifications using a moveable cursor 540 or any other suitable input device available on the media equipment device (e.g., keyboard and/or voice command). The navigation techniques available on the media equipment device may differ and be more convenient to use than those available on first mobile device 600 associated with first media guidance application 510. For example, first mobile device 600 may provide directional arrow keys 620 as the method of navigating mobile media guidance application 610 displayed on mobile device 600. Thus, while in order to make various selections on mobile device 600 the user may be required to use multiple keystrokes of directional arrow keys 620, media equipment device may allow the user to make the same selection by simple movement of moveable cursor 540 with a mouse input device.

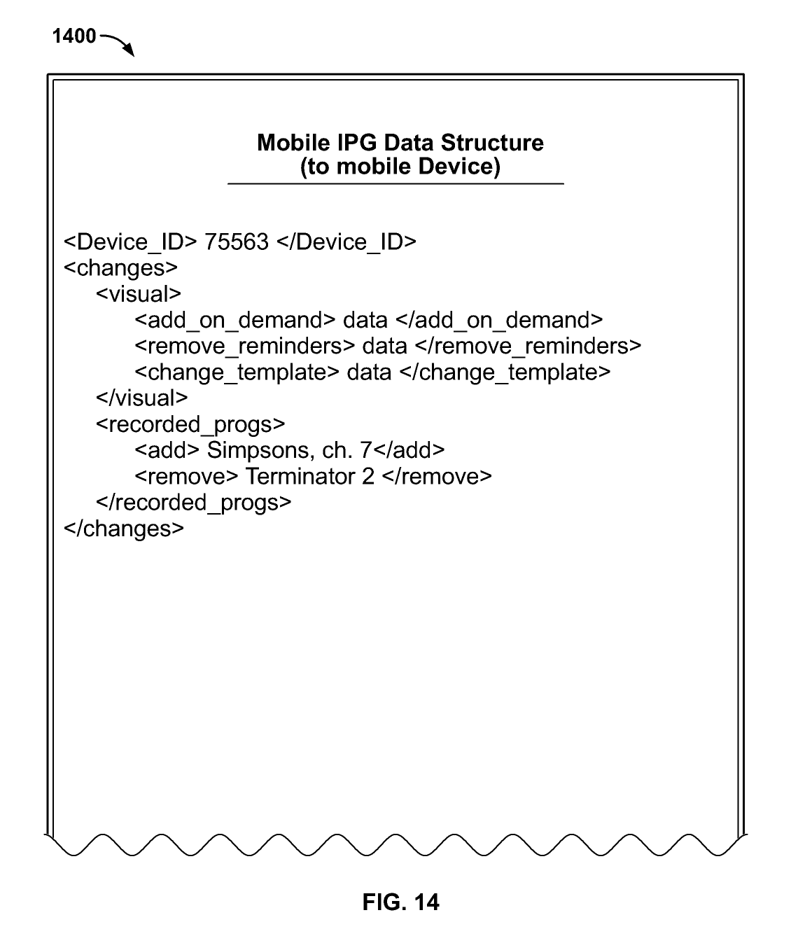

As the user navigates through and makes modifications to first media guidance application 510, processing circuitry 306 may track the changes made by storing the changes in a memory. When processing circuitry 306 receives a user selection of update mobile option 518, processing circuitry 306 may retrieve the tracked changes if any and transmit a mobile media guidance application data structure 1400 (FIG. 14) to first mobile device 600 associated with first media guidance application 510. Data structure 1400 may include various fields which indicate the changes made to the guide.

In some embodiments, the user may modify contents of media guidance applications that are displayed by moving items to and from displayed media guidance applications by way of dragging an item from one media guidance application and dropping the item into another media guidance application. For example, when first media guidance application 510 displays reminders that are associated with and stored on first mobile device 600, the user may select one or more of the displayed reminders to move to another media guidance application. In particular, the user may select one or more reminders displayed in first media guidance application 510 and drag the selected reminders into second media guidance application 520 and drop them in second media guidance application 520. As a result, processing circuitry 306 may add the selected one or more reminders to second media guidance application 520 and may transmit the added reminders as modifications to the mobile media guidance application stored on second mobile device 700 in data structure 1400. In some implementations, processing circuitry 306 may continuously update the content and settings of the mobile media guidance application of second mobile device 700 that are changed in second media guidance application 520. In some other implementations, processing circuitry 306 may update the content and settings of the mobile media guidance application of second mobile device 700 that are changed in second media guidance application 520 when processing circuitry 306 receives a user selection of update mobile option 528.

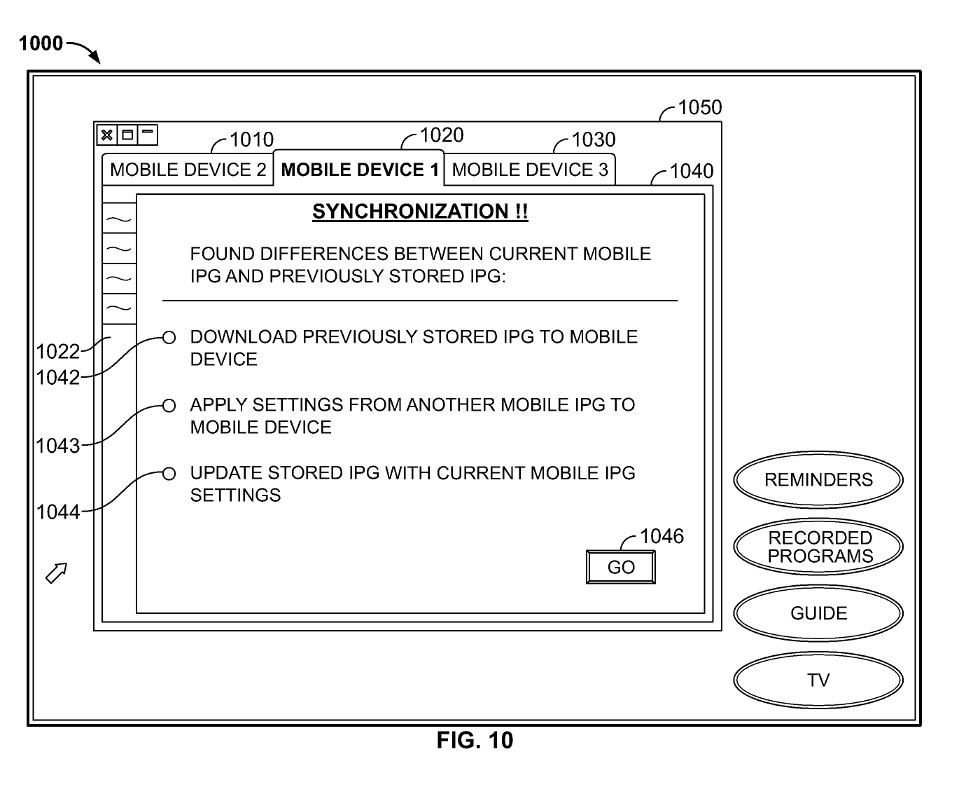

First mobile device 600 may receive data structure 1400 and may update mobile media guidance application 610 displayed on first mobile device 600 based on the received data structure 1400. As discussed in more detail below in connection with FIG. 10, first mobile device 600 may update mobile media guidance application 610 settings automatically or may first request confirmation from the user. Similarly, second media guidance application 520 may include an update mobile option 528 which when selected instructs processing circuitry 306 to transmit a data structure 1400 to second mobile device 700 associated with second media guidance application 520. Data structure 1400 that is transmitted may indicate which changes if any were made to second media guidance application 520 that need to be carried over to the mobile media guidance application displayed on second mobile device 700.

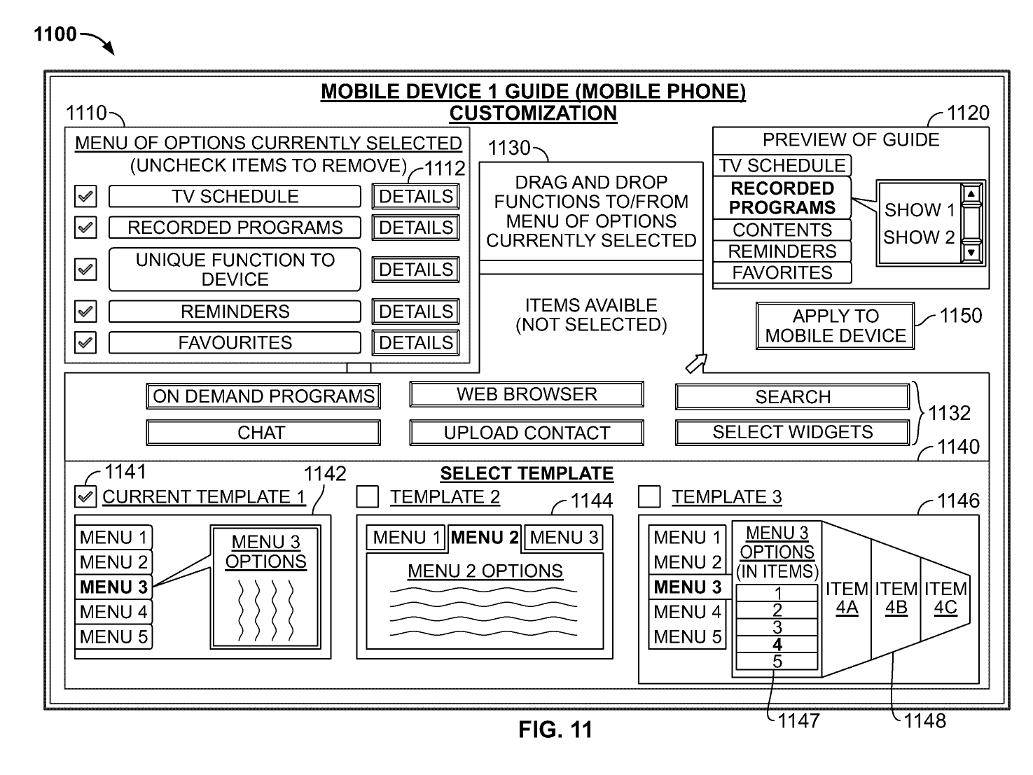

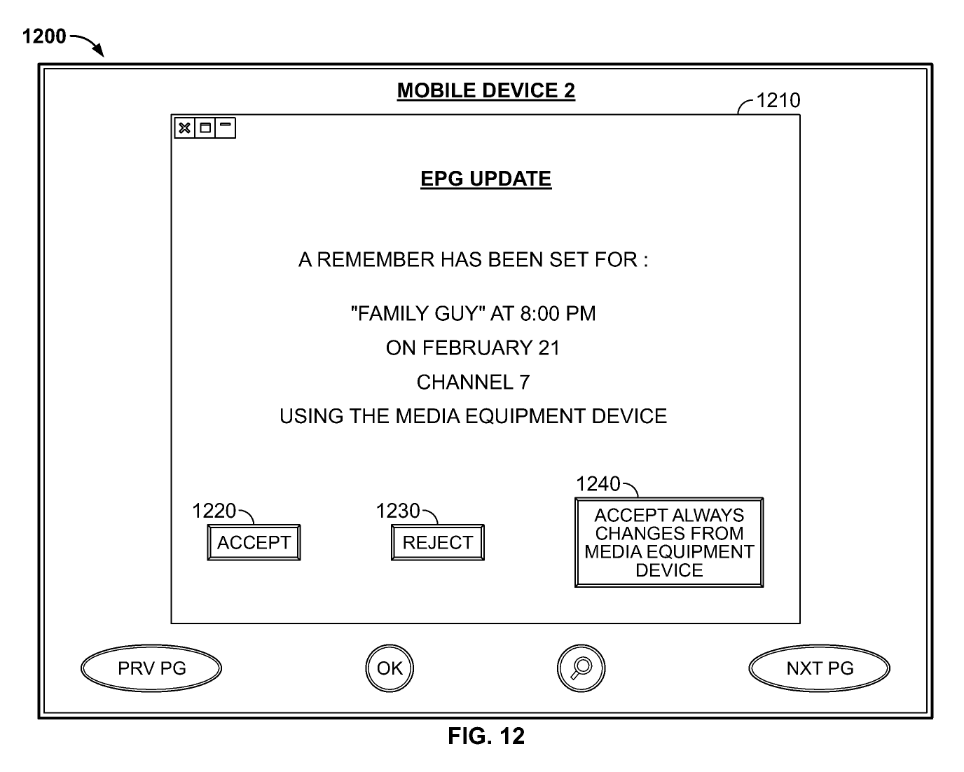

Processing circuitry 306 may receive a user selection of customize option 519. As a result, processing circuitry 306 may navigate the user to screen 1100 (FIG. 11) (discussed in greater detail below) which allows the user to customize the visual appearance or visual characteristics of the mobile media guidance application of the mobile device corresponding to the media guidance application. For example, processing circuitry 306 may receive a user selection of customize option 519 and after the user completes customizing the mobile media guidance application (through screen 1100), processing circuitry 306 may transmit a data structure 1400 indicating to the first mobile device associated with first media guidance application 510 what changes to the visual appearance need to be made.

In some implementations, customize option 519 may be available on first media guidance application 510 and not available on second media guidance application 520. For example, first media guidance application 510 may include customize option 519 when an associated first mobile device 600 supports the ability to change the visual appearance of mobile media guidance application 610. Second media guidance application 520 may not include a customize option when an associated second mobile device 700 has a mobile media guidance application hardwired and built into second mobile device 700 and thus may not be suited for customization.

Processing circuitry 306 may receive a user selection of mobile device guide option 530 and as a result may replace one of the displayed media guidance applications 510 or 520 with an media guidance application corresponding to a third mobile device. In some implementations, instead of replacing one of the displayed media guidance applications 510 or 520, processing circuitry 306 may add a third window to the display that includes an media guidance application corresponding to the third mobile device. Processing circuitry 306 may automatically adjust the sizes of the windows of first and second media guidance applications 510 and 520 to simultaneously display three media guidance applications each corresponding to a different mobile device.

In some implementations, processing circuitry 306 may adjust the sizes of the three displayed replicated mobile media guidance applications to be the same or processing circuitry 306 may adjust the sizes according to priorities given to different devices. For example, the user may assign a priority to a first device that is greater than priorities assigned to second and third devices. Accordingly, processing circuitry 306 may adjust the sizes of the three displayed windows such that the media guidance application corresponding to the first device with the highest priority is displayed in a larger window (e.g., larger in size) than the second and third media guidance applications corresponding to the second and third devices.

In some embodiments, each replicated mobile media guidance application that is displayed that corresponds to a particular mobile device may include an option to access functionality that is unique to the mobile device to which the replicated mobile media guidance application corresponds. For example, first media guidance application 510 may include an option to access a function unique to the first mobile device corresponding to first media guidance application 510 and second media guidance application 520 may include an option to access a function unique to the second mobile device corresponding to second media guidance application 520. The option that is included in the replicated mobile media guidance application that provides access to the unique functionality may include an identifier 515 or 525.

Identifiers 515 and 525 may indicate to the user that the option provides access to a functionality unique to the mobile device. In some implementations, where first media guidance application 510 mirrors the mobile media guidance application displayed on a given mobile device, identifier 515 may be displayed in first media guidance application 510 and omitted from the display of the mobile media guidance application on the mobile device, as shown in media guidance application 610 (FIG. 6).

Processing circuitry 306 may receive a user selection of contacts option of menu 512 and as a result may display items corresponding to the contacts option in place of items 516. Similarly, processing circuitry 306 may receive a user selection of e-books option of menu 522 and as a result may display items corresponding to the e-books option in place of television schedule 526.

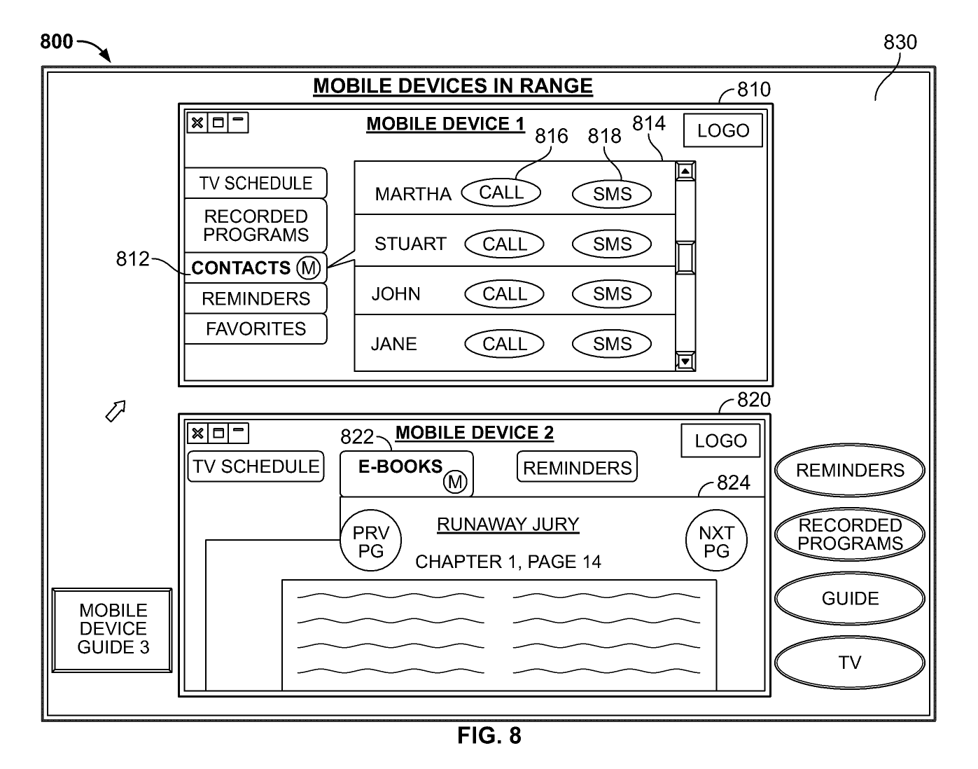

FIG. 8 shows an illustrative display screen 800 of multiple replicated mobile media guidance applications simultaneously displayed in accordance with an embodiment of the invention. Screen 800 may include a first media guidance application 810 which may be the same as first media guidance application 510 (FIG. 5) and second media guidance application 820 which may be the same as second media guidance application 520. First and second media guidance applications 810 and 820 may be overlaid over background 830 which may be the same as background 550 (FIG. 5).

First media guidance application 810 includes a menu region in which contacts option 812 is highlighted to show it has been selected by the user. First media guidance application 810 includes a corresponding items region that includes items associated with the selected contacts option 812. Contacts option 812 may be a function unique to first mobile device 600. In particular, contacts option 812 may provide the user with the ability to place telephone calls to users which are included in a stored telephone book list in first mobile device 600. More specifically, processing circuitry 306 may receive from first mobile device 600 in data structure 1300 a list of contacts stored in a memory of mobile device 600. In such circumstances, first mobile device 600 may be a cellular or mobile telephone device. The received list may be retrieved by processing circuitry 306 and may be used to generate items region 814 of first media guidance application 810. For example, items region 814 may include the list of contacts the user has stored in first mobile device 600.

Each of the contacts displayed in items region 814 may include a call option 816 and/or an SMS option 818. Processing circuitry 306 may receive a user selection of call option 816 and determine what resources the media equipment device needs from first mobile device 600 to place a call to the corresponding user. For example, processing circuitry 306 may receive a user selection of call option 816 and as a result may determine that the cellular transmission equipment (e.g., cellular antenna and digital signal processing circuitry) may be needed to place a call to a person Martha corresponding to the selected call option 816. Processing circuitry 306 may also determine that a speaker is necessary to provide voice received from the selected person (e.g., Martha) to the user and that a microphone is necessary to transmit voice from the user to the selected person (e.g., Martha). Processing circuitry 306 may determine that a microphone and speakers are readily available on the television unit and may therefore determine that the media equipment device need only consume the cellular transmission equipment from first mobile device 600 to complete the call (e.g., process the function unique to the first mobile device 600 with media equipment device).

In some embodiments, processing circuitry 306 may establish a continuous connection with first mobile device 600 using a short-range communications path or one or more other suitable communications paths as a result of receiving the user selection of call option 816. Processing circuitry 306 may transmit a communication to first mobile device 600 instructing first mobile device 600 to use the transmission equipment to place a call to the selected person (e.g., Martha). For example, processing circuitry 306 may instruct first mobile device 600 to dial a specific number corresponding to Martha. Processing circuitry 306 may receive voice data from first mobile device 600 and may provide the received voice data over speakers of the media equipment device. Similarly, processing circuitry 306 may receive voice data from the user over a microphone of the media equipment device and may transmit the voice data to first mobile device 600 for transmission over the cellular transmission equipment. In some embodiments, processing circuitry 306 may use voice-over-ip (VoIP) application (e.g., Skype) to complete the call to Martha when the user selects option 816. In particular, instead of dialing the telephone number using first mobile device 600, processing circuitry 306 may utilize an Internet connection available on the media equipment device to allow the user to communicate by voice with Martha in real-time.

In some implementations, processing circuitry 306 may receive a user selection of SMS option 818 and as a result may determine that the cellular transmission equipment (e.g., cellular antenna and digital signal processing circuitry) may be needed to send an SMS message to a person Martha corresponding to the selected SMS option 818. Processing circuitry 306 may determine that a continuous connection with first mobile device 600 may not be necessary to transmit the SMS message to Martha unlike call option 816. Accordingly, processing circuitry 306 may receive the text, image, video or other data message from the user when the user selects SMS option 818 and as a result processing circuitry 306 may transmit a communication to first mobile device 600 that contains a telephone number or other identifier of Martha as well as the message content(s) and that instructs first mobile device 600 to transmit the message to Martha over the cellular transmission equipment.

In some implementations, processing circuitry 306 may receive a user selection of SMS option 818 and as a result may determine that cellular transmission equipment (e.g., cellular antenna and digital signal processing circuitry) may not be needed to send an SMS message to a person Martha corresponding to the selected SMS option 818 but that an Internet connection available on the media equipment device is sufficient. Accordingly, processing circuitry 306 may receive the text, image, video or other data message from the user when the user selects SMS option 818 and as a result processing circuitry 306 may transmit the message to Martha over the Internet connection of the media equipment device.

Second media guidance application 820 includes a menu region in which e-books option 822 is highlighted to show it has been selected by the user. Second media guidance application 820 includes a corresponding items region that includes items associated with the selected e-books option 822. E-books option 822 may be a function unique to second mobile device 700. In particular, e-books option 822 may provide the user with the ability to read books electronically which are included in a stored book list in second mobile device 700. More specifically, processing circuitry 306 may receive from second mobile device 700 in data structure 1300 a list of electronic books stored in a memory of second mobile device 700. In such circumstances, second mobile device 700 may be an e-book device which allows the user to read books electronically on a display by downloading books from a third party server. The received list may be retrieved by processing circuitry 306 and may used to generate items region 824 of second media guidance application 820. For example, items region 824 may include the list of books the user has stored in second mobile device 700 or items region 824 may be a page of an electronic book the user is currently reading on second mobile device 700.

Each of the books displayed in items region 824 may be selected by the user. Processing circuitry 306 may receive a user selection of one of the books listed in items region 824 and determine what resources the media equipment device needs from second mobile device 700 to allow the user to view the book corresponding to the selection. For example, processing circuitry 306 may receive a user selection of a book and as a result may determine that the page last viewed of the selected book may be needed. Accordingly, processing circuitry 306 may transmit a communication to second mobile device 700 requesting the last viewed page of the selected book to be provided to the media equipment device. The last viewed page received from second mobile device 700 may then be displayed in second media guidance application 820. When the user selects a next page option or previous page option while reading the page of the book using the media equipment device, processing circuitry 306 may send subsequent communications to second mobile device 700 requesting the next or previous page of the selected book to be provided to the media equipment device.

In some implementations, processing circuitry 306 may receive multiple previous or next pages of the selected book from second mobile device 700 in order to avoid having to establish a connection with second mobile device 700 each time the user requests a next or previous page. In particular, processing circuitry 306 may cache the previous and next pages of the book being read on second media guidance application 820 to more quickly respond to user requests to view pages of the selected book. When the user is done reading the selected book, processing circuitry 306 may transmit data structure 1400 to second mobile device 700 indicating what page the user last read. This way, when the user next accesses the selected book using second mobile device 700, second mobile device 700 may present the last page the user read when the user was reading the book on the media equipment device instead of presenting the last page the user read when the user last read the book on second mobile device 700. Thus, the user may seamlessly transition from reading the book on second mobile device 700 to the media equipment device and back to second mobile device 700.

The user may also shop around for more electronic books using the media equipment device. Any electronic book the user decides to purchase or download with the media equipment device, may subsequently be downloaded to second mobile device 700 when an update to second mobile device 700 is performed.

In some embodiments, processing circuitry 306 may utilize both the unique functionality provided by first media guidance application 810 and the unique functionality provided by second media guidance application 820 to complete a request. For example, processing circuitry 306 may receive user request to transmit a portion of a page or the currently viewed page of the selected book being read in second media guidance application 820 to a contact listed in items region 814. In particular, processing circuitry 306 may receive a user selection from the book page displayed in second media guidance application 820 and may be instructed to transmit an SMS message that includes the selected book portion or page (using functionality discussed above in connection with SMS option 818) to a selected contact. Thus, processing circuitry 306 may connect to both first and second mobile devices 600 and 700 to complete the request. More specifically, processing circuitry 306 may communicate with second mobile device 700 to receive the selected book portion or page and may communicate with first mobile device 600 to transmit the SMS message to the selected person.

In some embodiments, a mobile device may include multiple unique functionalities. In such implementations, the replicated mobile media guidance application associated with the mobile device on the media equipment device may include a menu option for each of the unique functionalities of the mobile device. Functionalities which may be unique to one or more mobile device may include global positioning system (GPS) functionality which may be used to determine a current location of the mobile device and generate maps or media guidance application data based on that location. Other functionalities unique to the mobile devices may include gaming functionality. In such circumstances, a game or portion of the game that is implemented on the mobile device (e.g., a portable gaming machine) may be accessed on the media equipment device using the media guidance application generated for that mobile device. Other functionalities unique to the mobile devices may include music player (e.g., itunes) functionality which may provide access to one or more playlists of music or video media assets. Other functionalities unique to the mobile devices may include any application (e.g., game, utility, or function) that is executable on a given mobile device which may be accessed on the media equipment device with the media guidance application generated for that mobile device.

In some embodiments, a link to each of the replicated mobile media guidance applications generated based on mobile media guidance application data structure 1300 received from corresponding mobile devices may be displayed as a tab. In particular, the tab that is more prominently displayed than the other tabs may identify to the user to which mobile device the currently viewed media guidance application corresponds. The user may select each other tab to cause processing circuitry 306 display the replicated mobile media guidance application corresponding to the selected tab.

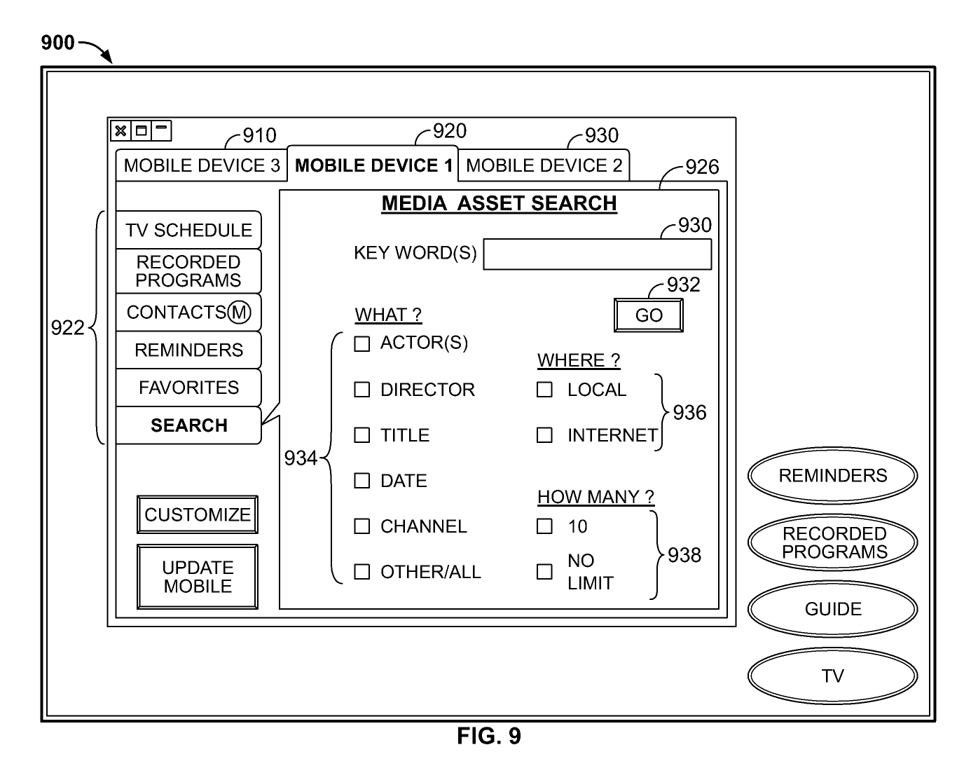

FIG. 9 shows an illustrative display screen 900 of multiple replicated mobile media guidance applications navigation in accordance with an embodiment of the invention. Screen 900 includes a first tab 910, a second tab 920 and a third tab 930 displayed in a window within the media guidance application or operating system of the media equipment device. First tab 910 may be a link to a third replicated mobile media guidance application associated with a third mobile device, second tab 920 may be a link to first media guidance application 510 associated with first mobile device 600 and third tab 930 may be a link to second media guidance application 520 (FIG. 5) associated with second mobile device 700.

Upon receiving selection of second tab 920 (e.g., by way of determining that a cursor is positioned over tab 920 and a button is pressed), processing circuitry 306 may retrieve first media guidance application 510 that is generated based on data structure 1300 received from first mobile device 600 to replicate the media guidance application of fist mobile device 600. First media guidance application 510 may be displayed in a region underneath or adjacent to the corresponding second tab 920. First media guidance application 510 displayed in the region underneath second tab 920 may include a menu 922 which may be the same as menu 512 discussed above in connection with FIG. 5. In some implementations, the tabs may be displayed along the vertical axis in an up/down manner and guides corresponding to the selected tabs may be displayed in a region to the left or to the right of the tabs.

Processing circuitry 306 may receive a user selection of search option 924 and as a result may display a search region 926 next to or adjacent menu 922. Search region 926 may include a search textbox 930, criteria selection region 934, search location selection region 936 and search limitation region 938. Processing circuitry 306 may receive input from the user through search textbox 520. For example, the user may provide a search string to processing circuitry 306 to use to search for and identify media assets. Criteria selection region 934 may be provided to allow the user to instruct processing circuitry 306 to narrow the search using certain criteria. For example, criteria selection region 934 may provide a list of criteria including, for example, TV Show, actor, director, film, band, musician, artist, album, titles, tracks, broadcast time and channel, broadcast date, any other suitable criteria or combination thereof which may be selected by marking corresponding checkboxes.

Processing circuitry 306 may execute the search based on the input search string after processing circuitry 306 receives a user selection of GO option 932. Processing circuitry 306 may search a local or remote database or storage device or any other location specified in region 936 (e.g., the Internet by using a Google search engine) for the search string included in the criteria specified with region 934. For example, when criteria region 934 specifies a TV Show, processing circuitry 306 may execute the search of remote databases, local databases, storage devices or websites that relate to TV Shows having the search string matching the string provided in textbox 930. The search may return multiple results or only a single result depending on how many items match the search.

The user may also be provided with an option to limit the number of search results by specifying limitations in region 938. When the search results are limited, processing circuitry 306 may prioritize the items that match the search string based on the closest matches and display a number of matching items less than or equal to the limit provided by the user. In some implementations, processing circuitry 306 may first search fields matching the criteria provided by the user of locally stored data structures and then when a number of items less than the limit are found, processing circuitry 306 may search remote databases. For example, when the criteria is a title, processing circuitry 306 may search title fields of media asset data structures (not shown) to determine whether the fields match the search string of textbox 930.

Processing circuitry 306 may generate a display in a window next to GO option 932 or as a new screen that includes a list with the items resulting from the search. The list may be interactive such that the user may add or mark favorite items in the list. For example, when the search yields media asset items, the user may select an add option to add a particular media asset in the interactive list to a profile associated with the user, schedule the selected media asset for recording, set a reminder for the selected media asset or playback or view the selected media asset. Processing circuitry 306 may transmit the search results and in some implementations the search terms corresponding to the search results to first mobile device 600 using data structure 1400. The search results may be included in mobile media guidance application 610 of first mobile device 600 and may be viewed by the user when the user accesses first mobile device 600. In such implementations, first mobile device 600 is freed of the processing power and burden of executing the search as the media equipment device (which may be more equipped to perform the search) is utilized to perform the search.

In some implementations, the user may input search criteria into first mobile device 600 using mobile media guidance application 610. When the user presses a GO option in mobile media guidance application 610, first mobile device 600 may transmit a data structure 1300 that includes the user specified search parameters to the media equipment device. Processing circuitry 306 on the media equipment device may execute and perform the search based on the receive data structure and return the results to first mobile device 600 using data structure 1400. This entire process may be automated such that the user of first mobile device 600 is seamlessly provided with the search results that are received from the media equipment device.

In some embodiments, processing circuitry 306 may determine that there exist differences between the mobile media guidance application and the corresponding replicated mobile media guidance application stored for the mobile device on the media equipment device. In particular, processing circuitry 306 may receive a mobile media guidance application data structure and compare the data of the mobile media guidance application with a previously stored version of the media guidance application. Processing circuitry 306 may allow the user to synchronize the replicated mobile media guidance application stored on the media equipment device with the one stored on the mobile device.

FIG. 10 shows an illustrative display screen 1000 of multiple replicated mobile media guidance applications navigation in accordance with an embodiment of the invention. Screen 1000 may include a similar display of tabbed replicated mobile media guidance applications navigation as discussed above in connection with FIG. 9. In particular, first tab 1010 may be the same or similar as first tab 910, second tab 1020 may be the same or similar as first tab 920 and third tab 1030 may be the same or similar as first tab 930. The tabbed guides may be displayed in a window 1050 overlaid on top of a background or as a menu portion of the media equipment device operating system.

Screen 1000 shows second tab 1020 corresponding to first mobile device 600 selected. An media guidance application 1022 generated based on mobile media guidance application data structure 1300 may be displayed adjacent second tab 1020. Media guidance application 1022 may be or appear to be the same or similar to the media guidance application displayed adjacent second tab 920 (FIG. 9). Processing circuitry 306 may determine differences or inconsistencies between a previously stored version of media guidance application 1022 on the media equipment device (e.g., version having different settings were previously stored) and the settings specified in the mobile media guidance application data structure received from first mobile device 600. In some implementations, instead of automatically updating the version stored on the media equipment device with the settings provided in the received mobile media guidance application data structure, processing circuitry 306 may display a prompt 1040 requesting user input.

Prompt 1040 may include a message indicating to the user that differences were detected between the mobile media guidance application settings and corresponding settings stored on the media equipment device. Prompt 1040 may provide a list of options that the user may select to instruct processing circuitry 306 on how to resolve the discrepancies. For example, prompt 1040 may include a first radio button 1042 which when selected instructs processing circuitry 306 to download the previously stored settings of the media guidance application to the mobile device. In particular, processing circuitry 306 may retrieve the settings stored for the media guidance application on the media equipment device and generate a mobile media guidance application data structure 1400 to transmit to first mobile device 600. First mobile device 600 may receive the data structure 1400 and apply the settings to the mobile media guidance application. Once completed, the mobile media guidance application may contain the same settings as the corresponding media guidance application on the media equipment device.

In some implementations, first radio button 1042 may be selected by the user to restore a previous version of the mobile media guidance application (e.g., because of a failure or inadvertent loss of data on the mobile device). In particular, first radio button 1042 may be used as a backup mechanism by which the integrity of the user's data and settings on the mobile device are preserved by the corresponding media guidance application stored on the media equipment device. In addition, the user may replace first mobile device 600 with another equivalent mobile device (e.g., user may exchange one cell phone model for another) but may have no other means to transfer settings of the mobile media guidance application between the two mobile devices. Accordingly, processing circuitry 306 may determine that first mobile device 600 has been replaced with a new mobile device by identifying that the settings transmitted in the data structure from the new mobile device are inconsistent with the one's stored. As a result, processing circuitry 306 may allow the user to select first radio button 1042 and update the settings of the new mobile device with those that were previously stored to the media equipment device by first mobile device 600.

Prompt 1040 may include a second radio button 1043 which when selected instructs processing circuitry 306 to apply settings from another mobile media guidance application to the mobile device. For example, the user may select second radio button 1043 to maintain consistency between settings of two different mobile devices. In particular, the user may like the visual appearance settings or the reminders set on second mobile device 700 and wish to have those same settings available on first mobile device 600. Accordingly, processing circuitry 306 may receive a user selection of second radio button 1043 and query the user as to which media guidance application settings of another mobile device to download to first mobile device 600. The user may select an option to download the settings associated with a mobile media guidance application of second mobile device 700 and as a result, processing circuitry 306 may transmit to first mobile device 600 a data structure 1400 that includes all the settings of the media guidance application of second mobile device 700. Processing circuitry 306 may also update the corresponding media guidance application settings stored on the media equipment device with the settings of the selected mobile media guidance application of second mobile device 700.

Prompt 1040 may include a third radio button 1044 which when selected instructs processing circuitry 306 update the settings of the replicated mobile media guidance application stored on the media equipment device with the settings of the mobile device. For example, processing circuitry 306 may retrieve the settings stored in the data structure 1300 received from first mobile device 600 and replace the settings stored on the media equipment device for the replicated mobile media guidance application corresponding to first mobile device 600 with the retrieved settings.

After the user selects a particular one of the radio buttons with the desired action, the user may select a GO option 1046. Processing circuitry 306 may receive a user selection of GO option 1046 and execute the necessary instructions based on the radio button selected by the user.

In some embodiments, processing circuitry 306 may receive a user selection of customize option 519. As a result, processing circuitry 306 may navigate the user to mobile device guide customization screen 1100 (FIG. 11) to allow the user to change the visual appearance of the media guidance application associated with the mobile device. In particular, the user may change settings which indicate how various menus and options appear on the mobile media guidance application on the mobile device and the replicated mobile media guidance application associated with the mobile device stored on the media equipment device.

FIG. 11 shows an illustrative display screen 1100 of mobile media guidance application customization in accordance with an embodiment of the invention. Screen 1100 may include a currently selected options region 1110, an items available that are not selected region 1130, a mobile media guidance application preview window 1120 and a template selection region 1140. As the user changes and selects various options to include or exclude from the replicated mobile media guidance application associated with a mobile device, processing circuitry may generate a preview of the media guidance application with the selected settings. The generated preview may be displayed in mobile media guidance application preview window 1120. Processing circuitry 306 may determine the display characteristics (e.g., screen dimensions) of the mobile device for which the mobile guide is being customized and generate the preview based on the determined display characteristics. More specifically, preview window 1120 allows the user to see what the mobile media guidance application would look like on the mobile device if the changes to the visual characteristics and settings were implemented.

Currently selected options region 1110 may include a list of the menu options and items which are enabled for display on the mobile media guidance application. The user may mark/unmark checkboxes for each menu option that the user would like to keep or remove. For example, processing circuitry 306 may receive a user selection unmarking the checkbox corresponding to unique function to the mobile device. As a result, processing circuitry 306 may remove that menu option from the mobile media guidance application and update the preview window 1120 to reflect that change. The number of items included in currently selected options region 1110 may reflect the number of items that the mobile media guidance application can fit in the display space of the mobile device. For example, first mobile device 600 may only have room to display five items in the mobile media guidance application and accordingly, currently selected options region 1110 may only allow the user to select five items. A details option 1112 may be provided next to each item to provide a description of a corresponding menu option.

In some implementations, when one of the checkboxes in currently selected options region 1110 is unmarked, a new menu option may be selected for inclusion in the mobile media guidance application. Accordingly, the user may drag one of the items 1132 from items available that are not selected region 1130 into currently selected options region 1110. As a result, processing circuitry 306 may add the dragged or selected item into currently selected options region 1110 and mark a corresponding checkbox to indicate that the selected item is enabled. Processing circuitry 306 may update preview window 1120 to reflect the removal and addition of the menu option. In some implementations, the user may position a cursor over one of items 1132 and double click or click a button on a mouse to cause the item over which the cursor is selected to be moved into currently selected options region 1110 and added to the mobile media guidance application.

The user may also customize the way in which menu options and items are presented in the media guidance applications displayed on the mobile and media equipment devices. Template selection region 1140 may include a variety of different design templates that may be used to modify the way in which menu options and items appear in the media guidance applications. Template selection region 1140 may include a current template selection 1141 and a template preview 1142 showing how the menu options and items are arranged. The user can see that since template selection 1141 is the currently selected template, there is a close resemblance between the way in which the menu options and items are shown to be arranged in template preview 1142 and mobile media guidance application 610 (FIG. 6) on first mobile device 600. A second and third template selection options may correspond to different design templates or ways in which the menu options and items of the media guidance applications are arranged.

For example, second template 1144 may include menu options and items that are similarly arranged as the menu options and items of the mobile media guidance application on second mobile device 700 (FIG. 7). Processing circuitry 306 may receive a user selection of second template 1144 and may as a result change the way in which options and items appear on first mobile device 600. Selection of second template 1144 may update the preview window 1120 to allow the user to see how the menu options and items that the user selected in region 1110 would appear in the modified media guidance application.

In some implementations, different templates may allow less menu options to be selected. Accordingly, when a different design template is selected that allows for fewer menu options to be provided or displayed, processing circuitry 306 may remove the requisite number of menu options from options currently selected region 1110. In some implementations, processing circuitry 306 may query the user as to which of the currently selected menu options to remove to make room for the newly selected design template. In some implementations, different design templates may allow more menu options to be selected. Accordingly, when a different design template is selected that allows for more menu options to be provided or displayed than the previously selected template, processing circuitry 306 may add the allowable number of menu options to options currently selected region 1110. In some implementations, processing circuitry 306 may query the user as to which of the items 1132 in items that are available and not selected region 1130 to add to currently selected options region 1110.

Third template 1146 may be a folding guide design in which menu options and items that are arranged in different perspective views. For example, menu options 1147 in the third template 1146 may be displayed in a first perspective view and items corresponding to a selected one of the menu options may be displayed adjacent menu options 1147 in a second perspective view that is different from the first perspective view. Folding guides or media guidance applications (media guidance application) with multiple perspective views are described in greater detail in U.S. patent application Ser. No. ______, filed ______ (Attorney Docket No. UV-486), which is hereby incorporated by reference herein in its entirety. Processing circuitry 306 may receive a user selection of third template 1146 and may as a result change the way in which options and items appear on first mobile device 600. Selection of third template 1146 may update the preview window 1120 to allow the user to see how the menu options and items that the user selected in region 1110 would appear in the modified media guidance application. Selection of the third template may be used to cause first mobile device 600 to display settings of an media guidance application using perspective views as in a folding guide implementation.

In some embodiments, the user may download/upload or design a design template. For example, the user may download a design template from a website and select and apply the downloaded design template to be used as the design template of the mobile media guidance application. In some implementations, the user may upload one design template from one mobile device and download the design template retrieved from the mobile device to a different mobile device. In some implementations, the user may create a design template using suitable design software on the media equipment device. The created design template may then be selected and applied as the design template for the mobile media guidance application.

Processing circuitry 306 may receive a user selection of apply to mobile device option 1150. As a result, processing circuitry 306 may generate a data structure 1400, for transmission to the selected mobile device, that includes the visual characteristics selected by the user in screen 1100. In some implementations, the user may select an option to apply the visual characteristics to more than one mobile device. In such circumstances, processing circuitry 306 may generate multiple data structures 1400 for transmission to each of the selected mobile devices. The mobile device or devices may receive the data structure(s) 1400 and may apply the settings to the stored mobile media guidance application to change the visual appearance of the mobile media guidance application to have the selected settings and functions.

In some embodiments, when settings are received by a mobile device (e.g., through a data structure 1400) that change settings and/or visual characteristics of a corresponding mobile media guidance application, the mobile device may alert the user before implementing the changes. In particular, instead of automatically accepting the changes made in the media equipment device, the mobile device may ask the user to confirm that the changes are acceptable before making the modifications to the mobile media guidance application.

FIG. 12 shows an illustrative display screen 1200 of an alert in a mobile media guidance application displayed on a mobile device in accordance with an embodiment of the invention. For example, second mobile device 700 may receive a data structure 1400 with changes to settings from the media equipment device. Second mobile device 700 may as a result prompt the user by way of displaying an alert 1210 about the incoming changes to the settings of the mobile media guidance application.

Alert 1210 may inform the user about each of the changes indicated in the received data structure. Alert 1210 may include an accept option 1220, a reject option 1230 and an accept always option 1240. Second mobile device 700 may receive a user selection of accept option 1220 and as a result may apply the changes specified in the received data structure 1400 to the mobile media guidance application settings stored in a memory of second mobile device 700. Second mobile device 700 may receive a user selection of accept always option 1240 and as a result may always apply the changes specified in the received data structure 1400, and any subsequent data structures 1400 received from the media equipment device, to the mobile media guidance application settings stored in a memory of second mobile device 700. Selection of accept always option 1240 may cause second mobile device 700 to not display alerts 1210 when changes are received from the media equipment device and in turn to automatically apply the received changes without inquiring or requiring confirmation from the user.

In some implementations, a separate alert 1210 may be provided for each individual change or modification and a separate accept option 1220 may have to be selected to apply each individual change to the mobile media guidance application. In some implementations, a list of the changes may be displayed in one alert 1210, and selection of accept option 1220 may apply all the changes specified in the list.

Second mobile device 700 may receive a user selection of reject option 1230 and as a result may not apply (or ignore) the changes specified in the received data structure 1400 to the mobile media guidance application settings stored in a memory of second mobile device 700. In some implementations, a separate alert 1210 may be provided for each individual change or modification and a separate reject option 1230 may have to be selected to not apply (or ignore) each individual change to the mobile media guidance application. In some implementations, a list of the changes may be displayed in one alert 1210, and selection of reject option 1230 may not apply (or ignore) all the changes specified in the list.

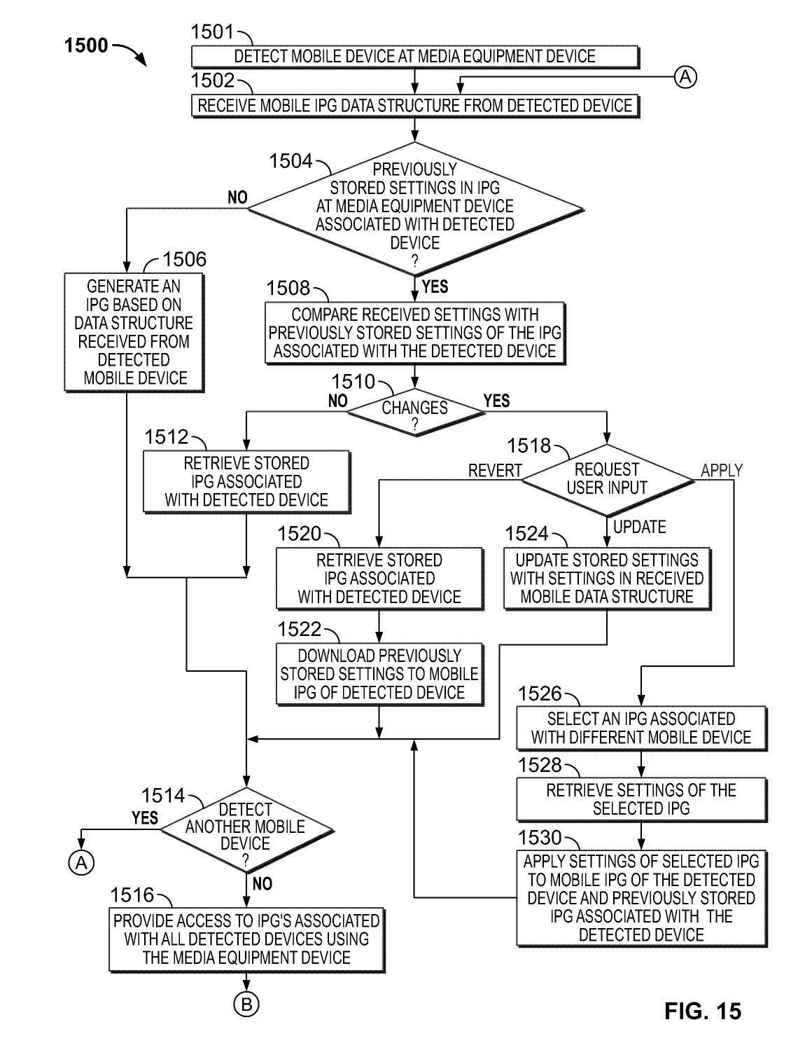

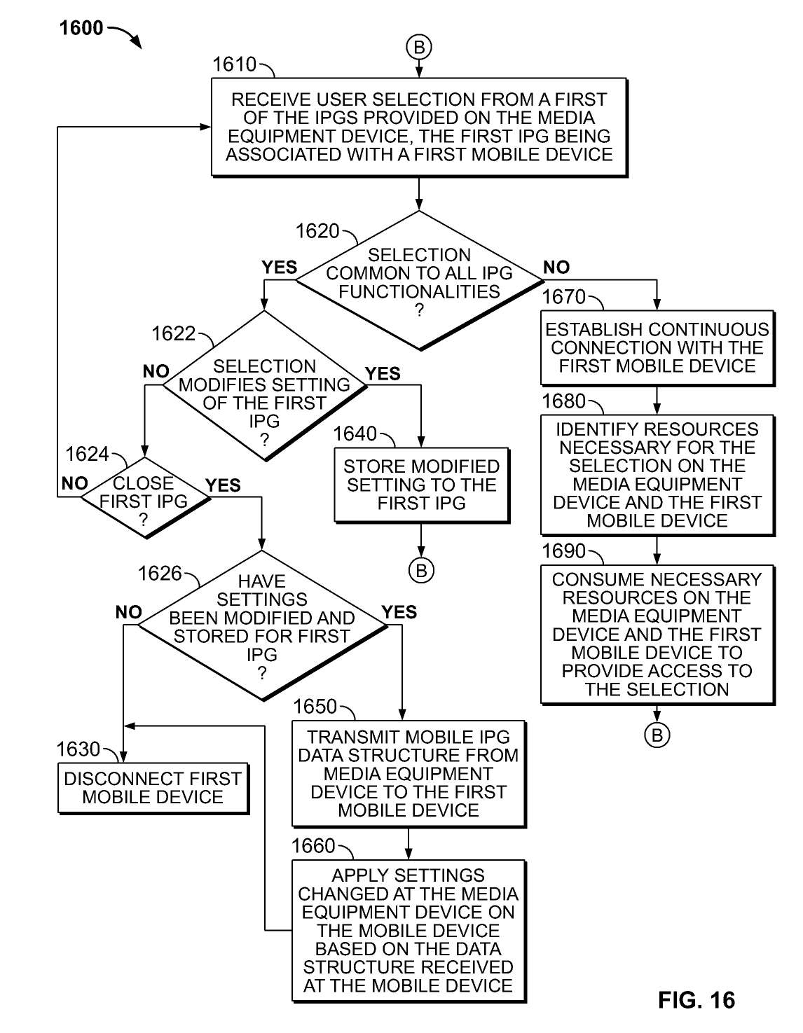

FIGS. 15 and 16 are illustrative flow diagrams 1500 and 1600 for multiple media guidance application navigation in accordance with embodiments of the present invention. At step 1501, a mobile device is detected using media equipment device. For example, a media equipment device may determine that first mobile device 600 is within a short-range communications path (or within a line or sight) of the media equipment device.

At step 1502, a mobile media guidance application data structure is received from the detected mobile device. For example, first mobile device 600 may transmit a mobile media guidance application data structure 1300 (FIG. 13) to the media equipment device that includes settings of mobile media guidance application 610 (FIG. 6).

At step 1504, a determination is made as to whether there exists previously stored settings in an media guidance application at the media equipment device associated with the detected mobile device. For example, processing circuitry 306 may retrieve a mobile device ID from the received data structure 1300 and determine whether any settings have been previously stored that are associated with that mobile device ID. When there exist previously stored settings in a replicated mobile media guidance application associated with the detected device, the process proceeds to step 1508, otherwise the process proceeds to step 1506.

At step 1506, an media guidance application is generated based on the data structure received from the detected mobile device to replicate the mobile media guidance application of the detected mobile device. For example, processing circuitry 306 may generate an media guidance application that includes the same settings (e.g., reminders, menu options, and other items) as mobile media guidance application 610.

At step 1508, the received settings in the data structure are compared with the previously stored settings of the media guidance application associated with the detected device. For example, processing circuitry 306 may compare settings specified in fields of the received data structure 1300 with the previously stored settings corresponding to first mobile device 600.

At step 1510, a determination is made as to whether there are changes between the previously stored media guidance application and the received settings. When changes are determined, the process proceeds to step 1518, otherwise the process proceeds to step 1512.

At step 1512, the stored media guidance application associated with the detected mobile device is retrieved. For example, processing circuitry 306 may retrieve the media guidance application associated with first mobile device 600 from a memory of the media equipment device.

At step 1518, a user input is requested. For example, processing circuitry 306 may generate prompt 1040 (FIG. 10) in which options are provided to the user. When the user input is a revert request (e.g., option 1042 is selected), the process proceeds to step 1520; when the user input is an update request (e.g., option 1044 is selected), the process proceeds to step 1524; and when the user input is an apply request (e.g., option 1043 is selected), the process proceeds to step 1526.

At step 1520, the media guidance application associated with the detected mobile device is retrieved. For example, processing circuitry 306 may retrieve the media guidance application associated with first mobile device 600 from a memory of the media equipment device.

At step 1522, the settings of the retrieved media guidance application that were previously stored on the media equipment device are downloaded to the detected mobile device. For example, processing circuitry 306 may package or generate a mobile media guidance application data structure 1400 (FIG. 14) that includes all the settings of the media guidance application retrieved from the memory of the media equipment device. The generated data structure 1400 may be transmitted to first mobile device 600.

At step 1524, the settings of the retrieved media guidance application that were previously stored on the media equipment device are updated with the settings of the data structure received from the detected mobile device. For example, first mobile device 600 may modify the settings of mobile media guidance application 610 with the settings specified in fields of data structure 1400 received from the media equipment device.

At step 1526, a replicated mobile media guidance application associated with a different mobile device is selected. For example, when processing circuitry 306 receives a user selection of option 1043 (FIG. 10), processing circuitry 306 may ask the user to specify a different mobile device from which to import settings to first mobile device 600.

At step 1528, settings of the selected replicated mobile media guidance application are retrieved. For example, processing circuitry 306 may retrieve a mobile media guidance application data structure associated with the selected device in which settings of the replicated mobile media guidance application of the selected device are stored.

At step 1530, the settings of the selected replicated mobile media guidance application that are retrieved are applied to the mobile media guidance application of the detected device and the previously stored media guidance application associated with the detected device. For example, processing circuitry 306 may package or generate a mobile media guidance application data structure 1400 (FIG. 14) that includes all the settings of the media guidance application associated with the selected mobile device and transmit the generated data structure 1400 to first mobile device 600. Processing circuitry 306 may also update the replicated mobile media guidance application stored in the media equipment device that is associated with first mobile device 600 with the settings of the replicated mobile media guidance application associated with the selected mobile device.

At step 1514, a determination is made as to whether another mobile device is detected. When another mobile device is detected, the process returns to step 1502, otherwise the process proceeds to step 1516.

At step 1516, access to the replicated mobile media guidance applications associated with the detected devices is provided using the media equipment device. For example, processing circuitry 306 may generate display screen 500 in which first media guidance application 510 associated with first mobile device 600 is displayed in a first window and second media guidance application 520 associated with second mobile device 700 is displayed in a second window (FIG. 5). In some implementations, processing circuitry 306 may provide access to first media guidance application 510 by receiving a user selection of second tab 920 and provide access to second media guidance application 520 by receiving a user selection of third tab 930 in a tabbed media guidance application display (FIG. 9). The process then proceeds to step 1610 (FIG. 16).

At step 1610, a user selection from a first of the replicated mobile media guidance applications provided on the media equipment device is received, where the first media guidance application is associated with a first mobile device. For example, processing circuitry 306 may receive a user selection to browse through first media guidance application 510 or delete or add various settings (e.g., reminders) to first media guidance application 510.

At step 1620, a determination is made as to whether the received selection is a selection of a function common to all the replicated mobile media guidance applications. For example, processing circuitry 306 may determine whether a selected menu option is available or common to all the replicated mobile media guidance applications (e.g., TV scheduled guide) or whether the selected menu option is unique to the mobile device (e.g., contacts function or e-book function). When the selection is common to all, the process proceeds to step 1622, otherwise the process proceeds to step 1670.

At step 1622, a determination is made as to whether the selection causes modification of a setting of the first media guidance application. When the selection causes a modification, the process proceeds to step 1640, otherwise the process proceeds to step 1624.

At step 1640, the modification of the setting is stored to the first media guidance application.

At step 1624, a determination is made as to whether the selection is an instruction to close the first media guidance application. When the selection is an instruction to close, the process proceeds to step 1626, otherwise the selection is processed and the process proceeds to step 1610.

At step 1626, a determination is made as to whether settings of the first media guidance application have been modified and stored. When the settings have been modified, the process proceeds to step 1650, otherwise the process proceeds to step 1630.

At step 1630, the first mobile device is disconnected.

At step 1650, a mobile media guidance application data structure is transmitted from the media equipment device to the first mobile device. For example, processing circuitry 306 may package or generate a mobile media guidance application data structure 1400 (FIG. 14) that includes all the settings of the replicated mobile media guidance application that have been changed or modified and transmit the generated data structure 1400 to first mobile device 600.

At step 1660, settings of the first media guidance application that have been changed or modified using the media equipment device are applied to the first mobile device based on the data structure received at the first mobile device. For example, first mobile device 600 may retrieve from fields in the received data structure the settings that have been changed or modified and may make the same changes or modifications to mobile media guidance application 610 stored on first mobile device 600.

At step 1670, a continuous connection is established with the first mobile device.

At step 1680, resources of the media equipment device and the first mobile device necessary for the selection are identified. For example, when the selection is a call option 816 (FIG. 8), processing circuitry 306 may determine that cellular transmission equipment resources of first mobile device 600 may be necessary and speakers and microphone equipment may be necessary from the media equipment device.

At step 1690, the necessary resources of the media equipment device and the first mobile device are consumed to provide access and processing of the received selection. For example, processing circuitry 306 may receive voice data from first mobile device 600 and provide that voice data over the media equipment device speakers; processing circuitry 306 may transmit voice data that is received from a microphone of the media equipment device to first mobile device 600; and first mobile device 600 may use the cellular transmission equipment to send the voice data to a selected person to whom the call is placed. The process then proceeds to step 1610.

It should be understood, that the above steps of the flow diagrams of FIGS. 15 and 16 may be executed or performed in any order or sequence no limited to the order and sequence shown and described in the figures. Also, some of the above steps of the flow diagrams of FIGS. 15 and 16 may be executed or performed substantially simultaneously where appropriate or in parallel to reduce latency and processing times.

The above described embodiments of the present invention are presented for purposes of illustration and not of limitation, and the present invention is limited only by the claims which follow.

1. A method for navigating an interactive program guide, the method comprising:
receiving with a media equipment device, first interactive program guide information from a first mobile device, wherein the first mobile device is configured to display a first mobile interactive program guide;
receiving with the first media equipment device, second interactive program guide information from a second mobile device different from the first mobile device, wherein the second mobile device is configured to display a second mobile interactive program guide;
generating a first interactive program guide based on the received first interactive program guide information;
generating a second interactive program guide based on the received second interactive program guide information; and
displaying, on the media equipment device, one of the first and second interactive program guides.

2. The method of claim 1, wherein the first interactive program guide information is received using a first short-range communications path and the second interactive program guide information is received using a second short-range communications path different from the first short-range communications path.

3. The method of claim 1, wherein the first and the second interactive program guides are displayed simultaneously.

4. The method of claim 3, wherein the first interactive program guide is displayed in a first window on a display of the first media equipment device and the second interactive program guide is displayed in a second window different from the first window.

5. The method of claim 1, further comprising:
displaying first and second options on the media equipment device, wherein:
the first interactive program guide is displayed in response to receiving a user selection of the first option; and
the second interactive program guide is displayed in response to receiving a user selection of the second option.

6. The method of claim 1, wherein the first interactive program guide is displayed, further comprising:
performing a function with the displayed first interactive program guide; and
transmitting data associated with the function to the first mobile device corresponding to the displayed first interactive program guide.

7. The method of claim 6, wherein performing the function comprises:
displaying a mobile interactive program guide customization screen that allows a user to customize the first mobile interactive program guide provided on the first mobile device;
changing a visual characteristic of the first mobile interactive program guide associated with the first interactive program guide based on options selected with the mobile interactive program guide customization screen.

8. The method of claim 7, wherein the mobile interactive program guide customization screen comprises a window in which a preview of how the first mobile interactive program guide that includes the changed visual characteristic will appear on the first mobile device.

9. The method of claim 7, further comprising:
receiving the data with the first mobile device; and
modifying a visual characteristic of the first mobile interactive program guide based on the received the data.

10. The method of claim 9 further comprising displaying a prompt at the first mobile device requesting confirmation prior to modifying the visual characteristic.

11. The method of claim 9 wherein the visual characteristic is modified without user input as a result of receiving the data.

12. The method of claim 6, wherein performing the function comprises:
executing a search for media assets using the first interactive program guide;
generating a list of media assets that result from the executed search.

13. The method of claim 6, wherein performing the function includes at least one of scheduling a media asset for recording, setting a reminder for a media asset, uploading an image, uploading a photograph, uploading a video, updating a list of previously accessed assets, and updating a list of favorite media assets.

14. The method of claim 1, wherein the first mobile interactive program guide is associated with the first interactive program guide information.

15. The method of claim 1, wherein visual characteristics of the first interactive program guide when displayed on the media equipment device are substantially the same as visual characteristics of the first mobile interactive program guide when displayed on the first mobile device.

16. The method of claim 1, wherein visual characteristics of the first interactive program guide when displayed on the media equipment device are different from visual characteristics of the first mobile interactive program guide when displayed on the first mobile device.

17. The method of claim 1, wherein the first interactive program guide is generated and displayed automatically when the first mobile device is within a short-range communications path of the media equipment device.

18. The method of claim 1 further comprising transmitting the first interactive program guide information from a first mobile device to the media equipment device automatically when the first mobile device is within a short-range communications path of the media equipment device.

19. The method of claim 17, wherein the short-range communications path is at least one of Bluetooth, WiFi, USB, firewire, infrared, and any combination of the same.

20. The method of claim 1, wherein the first interactive program guide provides first functionality unique to the first mobile device and the second interactive program guide provides a second functionality unique to the second mobile device.

21. The method of claim 20, wherein the first functionality comprises a telephony application and the second functionality comprises an email application.

22. A system for navigating an media guidance application, the system comprising:
a media equipment device that includes processing circuitry configured to:
receive, first media guidance application information from a first mobile device, wherein the first mobile device is configured to display a first mobile media guidance application;
receive, second media guidance application information from a second mobile device different from the first mobile device, wherein the second mobile device is configured to display a second mobile media guidance application;
replicate the first mobile media guidance application based on the received first media guidance application information;
replicate the second mobile media guidance application based on the received second media guidance application information; and
generate a display that includes one of the replicated first and second mobile media guidance applications.

23. The system of claim 22, wherein the first media guidance application information is received using a first short-range communications path and the second media guidance application information is received using a second short-range communications path different from the first short-range communications path.

24. The system of claim 22, wherein the replicated first and the second mobile media guidance applications are displayed simultaneously.

25. The system of claim 24, wherein the processing circuitry is further configured to generate in the display the replicated first mobile media guidance application in a first window and the replicated second mobile media guidance application in a second window different from the first window.

26. The system of claim 22, wherein the processing circuitry is further configured to:
generate in the display first and second options, wherein:
the replicated first mobile media guidance application is displayed in response to receiving a user selection of the first option; and
the replicated second mobile media guidance application is displayed in response to receiving a user selection of the second option.

27. The system of claim 22, wherein the replicated first mobile media guidance application is displayed, and wherein the processing circuitry is further configured to:
perform a function with the displayed replicated first mobile media guidance application; and
transmit data associated with the function to the first mobile device corresponding to the displayed replicated first mobile media guidance application.

28. The system of claim 27, wherein the processing circuitry is further configured to:
generate in the display a mobile media guidance application customization screen that allows a user to customize the first mobile media guidance application provided on the first mobile device; and
change a visual characteristic of the first mobile media guidance application associated with the first media guidance application based on options selected with the mobile media guidance application customization screen.

29. The system of claim 28, wherein the mobile media guidance application customization screen comprises a window in which a preview of how the first mobile media guidance application that includes the changed visual characteristic will appear on the first mobile device.

30. The system of claim 28, wherein the first mobile device is configured to:
receive the data; and
modify a visual characteristic of the first mobile media guidance application based on the received the data.

31. The system of claim 30 wherein the first mobile device is further configured to display a prompt requesting confirmation prior to modifying the visual characteristic.

32. The system of claim 30 wherein the visual characteristic is modified without user input as a result of receiving the data.

33. The system of claim 27, wherein the processing circuitry is further configured to:
execute a search for media assets using the replicated first mobile media guidance application; and
generate a list of media assets that result from the executed search.

34. The system of claim 27, wherein the processing circuitry is further configured to perform at least one of schedule a media asset for recording, set a reminder for a media asset, upload an image, upload a photograph, upload a video, update a list of previously accessed assets, and update a list of favorite media assets.

35. The system of claim 22, wherein the first mobile media guidance application is associated with the first media guidance application information.

36. The system of claim 22, wherein visual characteristics of the replicated first mobile media guidance application when displayed on the media equipment device are substantially the same as visual characteristics of the first mobile media guidance application when displayed on the first mobile device.

37. The system of claim 22, wherein visual characteristics of the replicated first mobile media guidance application when displayed on the media equipment device are different from visual characteristics of the first mobile media guidance application when displayed on the first mobile device.

38. The system of claim 22, wherein the processing circuitry is further configured to replicate the first mobile media guidance application and generate the display automatically when the first mobile device is within a short-range communications path of the media equipment device.

39. The system of claim 22 wherein the first mobile device is configured to transmit the first media guidance application information to the media equipment device automatically when the first mobile device is within a short-range communications path of the media equipment device.

40. The system of claim 38, wherein the short-range communications path is at least one of Bluetooth, WiFi, USB, firewire, infrared, HDMI and any combination of the same.

41. The system of claim 22, wherein the replicated first mobile media guidance application provides first functionality unique to the first mobile device and the replicated second mobile media guidance application provides a second functionality unique to the second mobile device.

42. The system of claim 41, wherein the first functionality comprises a telephony application and the second functionality comprises IPTV capabilities.

43-63. (canceled)
